(19) United States
(12) Patent Application Publication
(10) Pub. No.: US 2026/0364812 A1
(43) Pub. Date: Nov. 19, 2026

(54) HUMANOID ROBOT CONSTITUTION RUNTIME FOR GOVERNING PHYSICAL AI OPERATING SYSTEM EXECUTION

(71) Applicant: Dorian Cartwright, San Jose, CA (US)

(72) Inventor: Dorian Cartwright, San Jose, CA (US)

(21) Appl. No.: 19/731,091

(22) Filed: Jul. 5, 2026

(51) Int. Cl. B25J 11/00; B25J 9/16

(52) U.S. Cl. CPC B25J 11/0005; B25J 9/163

(57) ABSTRACT

A humanoid robot constitution runtime governs proposed humanoid robot operations before propagation into lower execution layers. A humanoid robot includes sensors, actuators, processors, and memory storing a machine-readable constitution defining constitutional provisions, authority domains, and persona constraints. A constitutional runtime associated with a Physical Artificial Intelligence Operating System (PAIOS) receives a proposed humanoid operation from an application, planner, behavior tree, large language model, vision-language-action model, operator interface, or other source. The constitutional runtime determines applicable authority domains and persona constraints, evaluates the proposed operation against the machine-readable constitution, resolves conflicts where applicable, and generates a constitutional enforcement output. The constitutional enforcement output may permit, deny, modify, route, or condition the proposed operation before the operation is propagated to a ROS2 middleware pathway, validation layer, actuation-dispatch trust layer, actuator firewall, driver, or actuator controller.

### CROSS-REFERENCE TO RELATED APPLICATIONS

This application is related to U.S. patent application Ser. No. 19/638,074, filed Apr. 2, 2026, by Dorian Cartwright and entitled PREDICTIVE ACTUATION GATING IN PHYSICAL ARTIFICIAL INTELLIGENCE (AI), the entire contents of which are incorporated herein by reference.

This application is related to U.S. patent application Ser. No. 19/686,121, filed May 22, 2026, by Dorian Cartwright and entitled OWNERSHIP-GATED MISSION AUTHORIZATION AND CUSTODY CONTROL FOR MOBILE PHYSICAL ARTIFICIAL INTELLIGENCE (AI) AGENTS, the entire contents of which are incorporated herein by reference.

This application is related to U.S. Provisional Patent Application No. 64/070,365, filed May 20, 2026, by Dorian Cartwright and entitled PROTECTED PHYSICAL ARTIFICIAL INTELLIGENCE (AI) ACTUATOR FIREWALL OPERATING SYSTEM, the entire contents of which are incorporated herein by reference.

This application is related to U.S. Provisional Patent Application No. 64/100,701, filed Jun. 28, 2026, by Dorian Cartwright and entitled MANDATORY ACTUATION-DISPATCH TRUST ARCHITECTURE FOR PHYSICAL ARTIFICIAL INTELLIGENCE (AI) SYSTEMS, the entire contents of which are incorporated herein by reference.

This application is related to U.S. patent application Ser. No. 19/711,880, filed May 20, 2026, by Dorian Cartwright and entitled PHYSICAL ARTIFICIAL INTELLIGENCE OPERATING SYSTEM, the entire contents of which are incorporated herein by reference.

### FIELD OF THE INVENTION

The present disclosure relates generally to computers and artificial intelligence, and more specifically, to a humanoid robot constitution runtime for governing proposed humanoid robot operations before such operations are propagated through a Physical Artificial Intelligence Operating System (PAIOS), ROS2 middleware, robot middleware, validation layer, actuation-dispatch trust layer, actuator firewall, actuator driver, or actuator controller.

### BACKGROUND

Humanoid robots are increasingly being developed for operation in homes, offices, factories, hospitals, schools, retail environments, sidewalks, airports, warehouses, elder-care environments, entertainment venues, and other spaces shared with humans. Unlike conventional industrial robots that operate in cages or highly constrained workcells, humanoid robots are expected to move through human environments, speak with humans, manipulate human objects, perceive private spaces, accept commands from different persons, enter public and private domains, and perform roles that change over time.

Modern humanoid robots may include application software, mission planners, behavior trees, large language model planners, vision-language-action models, learned policies, robot middleware, ROS2 nodes, Physical AI Operating System services, validation layers, actuation-dispatch layers, actuator firewalls, motor drivers, and hardware controllers. Each layer may make local decisions concerning communication, planning, safety, routing, dispatch, or motor execution. However, existing robot software stacks generally lack a persistent, machine-readable constitutional runtime layer that governs proposed humanoid operations according to authority domains, persona constraints, role states, and constitutional priority rules before those operations propagate into lower execution layers.

Conventional robot operating systems and middleware frameworks may provide message transport, node execution, topic publication, service invocation, action interfaces, hardware abstraction, device drivers, or control pipelines. For example, a middleware layer may transport a proposed movement command from a planner to a controller, or may enable modular nodes to exchange sensor and action messages. Such middleware does not itself define a humanoid robot's constitutional identity, authority hierarchy, role bound behavioral limitations, or persona state. Nor does it determine whether an owner instruction is subordinate to a premises rule, whether a workplace role is compatible with a child-safe interaction mode, or whether a public-space obligation constrains a proposed humanoid behavior before the command is routed downstream.

Similarly, existing physical validation systems may determine whether a proposed physical action is safe, feasible, balanced, collision-free, or within a predicted execution envelope. Such systems are important, but they address physical feasibility rather than constitutional permissibility. A proposed humanoid operation may be physically safe yet constitutionally impermissible because the command originates from an unauthorized authority domain, conflicts with an active persona constraint, violates a public space behavioral obligation, or attempts to place the humanoid robot into an unauthorized role.

Existing actuation-dispatch trust architectures and actuator firewall systems may control whether candidate physical actions reach actuator controllers, normalize candidate physical actions into policy evaluable action objects, require state bound actuator dispatch authorizations, or prevent motor side execution without a valid release authorization. Such systems may own or protect the actuator dispatch path, but they generally do not define the higher-level constitutional rules that determine who may command the humanoid robot, what persona the robot may adopt, what behavioral protocol applies, or which authority domain controls when multiple human or institutional authorities conflict.

Existing artificial intelligence alignment approaches, including constitutional AI for chatbots, generally govern text outputs or model responses using prompts, principles, training procedures, reinforcement learning, self critique, or output filtering. Such systems are not designed as operating system level constitutional runtimes for embodied humanoid robots. They do not provide a machine-readable constitution that is evaluated before physical execution through PAIOS services, ROS2 pathways, validation layers, actuation dispatch layers, actuator firewalls, or motor control systems.

Existing behavior trees, task planners, access-control systems, and policy engines are also inadequate. A behavior tree may describe how a robot performs a task, but not whether the humanoid robot is constitutionally permitted to adopt a role, select the behavior tree, interact with a child, obey an employer over an owner, enter a hospital room, disclose sensor data, override a household command, or invoke an actuator-dispatch trust path. Access-control systems may determine whether a subject may access a digital resource, but they do not define role-bound physical behavior, humanoid persona, constitutional priority, and downstream physical execution constraints.

Accordingly, there is a need for a robust humanoid robot constitution runtime positioned within, above, or associated with a Physical AI Operating System. There is a further need for such a constitution runtime to evaluate proposed humanoid operations before propagation into ROS2 middleware, validation layers, actuation-dispatch trust layers, actuator firewalls, motor drivers, or other lower execution systems. There is also a need for the constitution runtime to generate constitutional enforcement outputs that permit, deny, modify, route, condition, or constrain proposed humanoid operations based on authority domains, persona constraints, role states, and constitutional priority relationships.

### SUMMARY

The present disclosure addresses these shortcomings with systems, methods, and computer program products for a humanoid robot constitution runtime.

In one embodiment, a humanoid robot includes a humanoid body having a plurality of actuators, one or more sensors, one or more processors, and memory storing a machine-readable constitution. The machine-readable constitution defines constitutional provisions for the humanoid robot, including authority domains, persona constraints, role states, constitutional priority relationships, and downstream enforcement bindings. A constitutional runtime associated with the humanoid robot evaluates proposed humanoid operations before the proposed humanoid operations are propagated into lower execution layers.

In one embodiment, the constitutional runtime operates within, above, or in association with a PAIOS. The constitutional runtime may be implemented as a privileged runtime service of the PAIOS, as a trusted middleware service, as a secure execution service, as an onboard robot service, as a distributed edge/cloud service associated with the humanoid robot, or as a combination thereof. The constitutional runtime receives proposed humanoid operations from one or more upstream control sources, including application software, mission planners, behavior trees, large language models, vision-language-action models, learned robot policies, remote operator interfaces, fleet controllers, or scripts.

In one embodiment, the proposed humanoid operation includes at least one of a locomotion operation, manipulation operation, speech operation, gaze operation, sensing operation, recording operation, disclosure operation, role-adoption operation, mission operation, navigation operation, or human-interaction operation. The constitutional runtime determines one or more authority domains applicable to the proposed humanoid operation. The authority domains may include, for example, an owner domain, custodian domain, employer domain, household domain, premises domain, local-law domain, public-space domain, emergency-responder domain, manufacturer domain, bystander domain, or data-subject domain.

In one embodiment, the constitutional runtime determines one or more persona constraints applicable to the proposed humanoid operation. The persona constraints may govern speech style, gesture, gaze, proxemic distance, manipulation force, locomotion style, sensing behavior, disclosure behavior, public-space mode, household mode, workplace mode, child-safe mode, emergency mode, maintenance mode, or other role-bound behavioral limits of the humanoid robot.

In one embodiment, the constitutional runtime evaluates the proposed humanoid operation against the machine-readable constitution based on the applicable authority domain, persona constraint, and constitutional provisions. When multiple constitutional provisions apply, the constitutional runtime may resolve a conflict according to a constitutional hierarchy, priority table, rule-priority graph, conflict-resolution rule, or other machine-readable priority relationship.

In one embodiment, the constitutional runtime generates a constitutional enforcement output. The constitutional enforcement output may permit, deny, modify, route, delay, condition, or audit the proposed humanoid operation. The constitutional enforcement output may include a permit decision, deny decision, modify decision, constrained action descriptor, constitutional metadata object, constitutional release token, required validator indicator, downstream constraint object, or other machine-readable output.

In one embodiment, the constitutional enforcement output is provided to one or more lower execution layers before physical execution. The lower execution layers may include a PAIOS service, ROS2 middleware layer, robot middleware layer, validation layer, actuation-dispatch trust layer, actuator firewall, actuator driver, actuator controller, or motor-control layer. In some embodiments, the constitutional runtime controls whether a proposed humanoid operation is published to a ROS2 topic, transmitted as a ROS2 action, provided to a ROS2 service, routed through a robot middleware pathway, submitted to a validation layer, passed to an actuation dispatch trust layer, or delivered to an actuator firewall.

In one embodiment, the constitutional enforcement output is provided to a validation layer configured to evaluate physical feasibility, physical safety, balance, collision risk, manipulation risk, tactile risk, or other execution risk. In another embodiment, the constitutional enforcement output is provided to an actuation-dispatch trust layer configured to require state-bound authorization before actuator dispatch. In another embodiment, the constitutional enforcement output is provided to an actuator firewall configured to perform actuator-side gating, command-release control, or motor-side authorization.

Advantageously, the disclosed humanoid robot constitution runtime provides a root constitutional governance layer for humanoid robot operation. The constitutional runtime does not merely determine whether an action is physically safe, and does not merely authenticate an owner or mission. Instead, the constitutional runtime determines whether a proposed humanoid operation is constitutionally permissible under applicable authority domains, persona constraints, and constitutional priority relationships before the operation is propagated into lower robot execution layers.

Many other variations are possible.

### BRIEF DESCRIPTION OF FIGURES

The present disclosure will be understood more fully from the detailed description given below and from the accompanying drawings of various embodiments of the disclosure.

FIG. 1 is a diagram illustrating a humanoid robot constitutional governance hierarchy, according to an embodiment.

FIG. 2 is a diagram illustrating a humanoid robot including a constitutional engine in the context of a PAIOS, ROS2, a validation layer, and an actuator firewall, according to an embodiment.

FIG. 3 is a diagram illustrating a detailed constitutional engine of the humanoid robot of FIG. 1, according to an embodiment.

FIG. 4 is a flow diagram illustrating an overall method for governing a proposed humanoid operation using a humanoid robot constitution, according to an embodiment.

FIG. 5 is a flow diagram illustrating a method for loading or instantiating a machine-readable constitution and constitutional runtime objects, according to an embodiment.

FIG. 6 is a flow diagram illustrating a method for evaluating a proposed humanoid operation against authority domains, persona constraints, and a constitutional hierarchy, according to an embodiment.

FIG. 7 is a flow diagram illustrating a method for generating a constitutional enforcement output and providing the constitutional enforcement output to one or more downstream systems, according to an embodiment.

FIG. 8 is a flow diagram illustrating a method for updating a constitutional state, role state, or persona state associated with a humanoid robot, according to an embodiment.

### DETAILED DESCRIPTION

The description below provides systems, methods, and computer program products for humanoid robot constitution governance.

### I. Systems

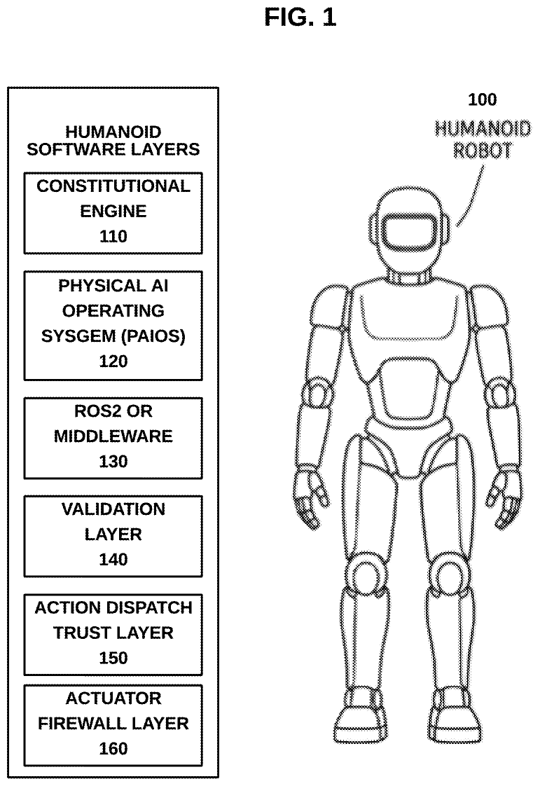

### A. Humanoid Robot Constitutional Governance Hierarchy (FIG. 1)

FIG. 1 illustrates a humanoid robot constitutional governance hierarchy of a humanoid robot 100, according to an embodiment. The humanoid robot 100 operates under a constitutional engine 110 implementing a constitutional governance layer. Beneath or associated with the constitutional governance layer 110 may be a PAIOS layer 120, a ROS2 or middleware layer 130, a validation layer 140, an actuation-dispatch trust layer 150, and an actuator firewall layer 160. Many other embodiments are possible.

As used herein, a humanoid robot constitution refers to a machine-readable governance framework that establishes the authority structure under which one or more operational policies governing a humanoid robot are created, prioritized, activated, interpreted, modified, suspended, and resolved. The constitution therefore governs the policies themselves rather than merely specifying individual robot behaviors. Unlike an operational policy that directly constrains a particular behavior, the constitution defines authority domains, constitutional priorities, constitutional obligations, amendment relationships, conflict-resolution rules, persona relationships, and other governance structures that determine which operational policies apply to a proposed humanoid operation.

An operational policy generally governs one or more specific robot behaviors, such as locomotion speed, manipulation force, recording permissions, speech restrictions, proximity limits, object-handling rules, sensing permissions, or navigation constraints. By contrast, the constitution determines which operational policies are active, which policies override other policies, which entities may create or modify policies, and how conflicts among multiple policies are resolved. Accordingly, the constitution operates as a governance framework above individual operational policies.

In one embodiment, the constitution is implemented as a machine-readable constitution accessible by the constitutional engine 110. The machine-readable constitution may comprise structured records, manifests, schemas, policy objects, graphs, lookup tables, state machines, executable runtime objects, serialized data structures, signed objects, or combinations thereof. The machine-readable constitution may be stored in protected memory, nonvolatile storage, trusted execution environments, secure enclaves, cloud services, edge services, or other storage accessible by the constitutional engine 110.

Different humanoid robots, organizations, operators, or environments may utilize different constitutions. For example, a household robot may operate under a household constitution emphasizing privacy, child safety, property protection, and guest interaction. A hospital robot may operate under a healthcare constitution emphasizing patient privacy, caregiver authority, infection-control procedures, and regulated medical workflows. A warehouse robot may operate under an industrial constitution emphasizing worker safety, equipment protection, restricted operational zones, and collaborative material handling. Likewise, educational robots, hospitality robots, municipal robots, security robots, manufacturing robots, military robots, emergency response robots, retail robots, or other humanoid robots may each operate under constitutions adapted to their respective operational environments.

In some embodiments, multiple constitutions may coexist for a single humanoid robot. For example, a manufacturer constitution may define immutable platform-level rules, while an organizational constitution defines enterprise operational rules, a premises constitution defines building-specific requirements, and a mission constitution defines temporary mission-specific constraints. The constitutional engine 110 may determine which constitutional provisions are active according to constitutional priority relationships, authority domains, role states, operational context, mission context, environmental conditions, or other machine-readable conditions.

The constitutional governance layer 110 receives proposed humanoid operations from one or more downstream control sources including application software, mission planners, behavior trees, large language models, vision-language-action models, learned robot policies, remote operators, fleet controllers, autonomous agents, or other artificial intelligence systems. Regardless of the origin of the proposed humanoid operation, the constitutional governance layer 110 determines whether, and under what constitutional constraints, the proposed operation may proceed toward downstream execution. In some embodiments, the constitutional governance layer 110 generates constitutional enforcement outputs including permit decisions, deny decisions, constrained action descriptors, constitutional metadata, constitutional release tokens, required-validator indicators, or other machine-readable governance outputs.

In various embodiments, the machine-readable constitution comprises an executable governance specification rather than merely a static policy document. The machine-readable constitution may define one or more authority domains, constitutional provisions, role definitions, persona definitions, obligations, permissions, restrictions, priority relationships, conflict-resolution rules, inheritance relationships, exception rules, constitutional metadata, or other governance constructs that are evaluated by the constitutional engine during runtime. The constitutional engine may therefore execute the machine-readable constitution as part of normal operation of the humanoid robot.

Different machine-readable constitutions may be deployed for different robots, organizations, jurisdictions, customers, missions, or operating environments. For example, separate constitutions may be associated with residential robots, hospital robots, warehouse robots, military robots, educational robots, industrial robots, public-space robots, hospitality robots, elder-care robots, or entertainment robots. Multiple constitutions may coexist simultaneously, with constitutional provisions inherited, overridden, prioritized, activated, suspended, or combined according to constitutional hierarchy rules.

The constitutional governance layer 110 may be implemented within, above, or associated with a PAIOS. In one embodiment, the constitutional governance layer operates as a privileged runtime service of the PAIOS and evaluates proposed humanoid operations before the proposed operations are propagated into lower execution layers. The constitutional governance layer therefore serves as the principal governance interface between high-level humanoid decision making and downstream robot execution services.

The PAIOS layer 120 provides system level runtime services for Physical AI operation, including execution coordination, runtime management, and service orchestration. The ROS2 or middleware layer 130 provides message transport, node communication, service invocation, action transport, topic publication, and communication pathways among robot software components. The validation layer 140 evaluates physical safety, feasibility, stability, balance, collision risk, or other execution risks associated with constitutionally permissible operations. The actuation dispatch trust layer 150 provides a mandatory dispatch pathway through which candidate physical actions are routed before actuator side commitment. The actuator firewall layer 160 provides actuator proximate gating, command normalization, release control, or other actuator side enforcement functions.

Unlike conventional policy engines that evaluate isolated rules after software execution has already progressed, the constitutional governance layer operates as a persistent governance runtime positioned above one or more Physical Artificial Intelligence Operating System (PAIOS) services, robot middleware services, validation services, trust-dispatch services, and actuator protection services. The constitutional governance layer determines how downstream policy decisions are interpreted, prioritized, and enforced before proposed humanoid operations propagate toward physical execution.

In one embodiment, the constitutional governance layer 110 is architecturally distinct from the downstream execution layers. The constitutional governance layer determines whether a proposed humanoid operation is constitutionally permissible based on authority domains, persona constraints, constitutional provisions, and constitutional priority relationships. The validation layer 140 determines whether a constitutionally permissible operation is physically safe or feasible. The actuation dispatch trust layer 150 determines whether a constitutionally permissible and physically validated operation receives state bound authorization for actuator dispatch. The actuator firewall layer 160 determines whether the authorized operation is permitted to reach one or more actuator controllers or actuator endpoints. Consequently, the constitutional governance layer governs constitutional permissibility, while downstream layers govern physical validation, trusted dispatch, and actuator-side execution.

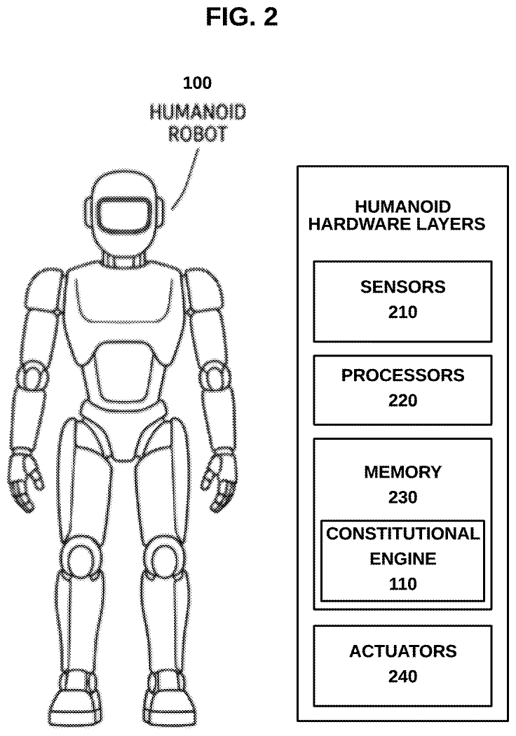

### B. Humanoid Robot Hardware With Constitution Engine (FIG. 2)

FIG. 2 illustrates a humanoid robot system 200 including hardware and software components configured to implement constitutional governance, according to an embodiment. The humanoid robot system 200 includes one or more sensors 210, one or more processors 220, memory 230, and a constitutional engine 240. The constitutional engine 240 may be implemented onboard the humanoid robot 100, within a trusted runtime partition, as a privileged runtime service of a PAIOS, within a secure execution environment, or in a distributed form associated with the humanoid robot 100. Many other embodiments are possible.

The sensors 210 obtain information associated with the physical environment, the humanoid robot, nearby humans, objects, and mission context. The sensors 210 may include cameras, depth sensors, lidar, radar, microphones, inertial measurement units, tactile sensors, force sensors, torque sensors, joint encoders, pressure sensors, proximity sensors, GPS receivers, wireless positioning devices, environmental sensors, biometric sensors, or other sensing devices. Sensor data may be used to determine contextual state, human proximity, object identity, environmental conditions, location, robot status, or other information relevant to constitutional evaluation.

The one or more processors 220 execute computer-executable instructions associated with constitutional governance and other robot operations. The processors 220 may include one or more central processing units (CPUs), graphics processing units (GPUs), neural processing units (NPUs), tensor processors, digital signal processors (DSPs), microcontrollers, real-time processors, secure processors, or combinations thereof. The processors 220 may execute application software, PAIOS runtime services, ROS2 nodes, middleware services, validation services, constitutional runtime services, and other software components that collectively govern operation of the humanoid robot.

The memory 230 stores executable software, runtime data, and machine-readable information used by the humanoid robot. The memory 230 may comprise volatile memory, non-volatile memory, flash memory, solid-state storage, secure memory, cache memory, high-bandwidth memory, or combinations thereof. The memory 230 may store one or more application modules a PAIOS, a ROS2 or middleware layer, a constitutional engine 240, a machine-readable constitution, constitutional runtime objects, one or more validation modules, and one or more actuator firewall interface modules. Additional software modules may also be stored in memory, including mission-planning software, navigation software, manipulation software, perception software, communication software, audit software, or other robot-control software.

The application modules may generate proposed humanoid operations based on user requests, autonomous planning, behavior trees, large language models, vision-language-action models, learned robot policies, operator commands, or fleet management instructions. The PAIOS provides system-level runtime services for Physical AI operation, while the ROS2 or middleware layer provides message transport, node execution, topic publication, service invocation, action transport, and communication among robot software components. The validation modules may evaluate physical feasibility, safety, stability, collision risk, manipulation risk, balance, or other execution-related constraints before physical execution.

The constitutional engine 240 receives proposed humanoid operations generated by one or more application modules before the proposed humanoid operations are propagated into one or more downstream execution layers. The constitutional engine 240 accesses the machine-readable constitution, determines one or more applicable authority domains, persona constraints, and constitutional provisions, evaluates the proposed humanoid operations, and generates one or more constitutional enforcement outputs. The constitutional enforcement outputs may include permit decisions, deny decisions, constrained action descriptors, constitutional metadata objects, constitutional release tokens, required-validator indicators, downstream constraint objects, or other machine-readable outputs.

In some embodiments, one or more constitutional enforcement outputs are generated independently of physical validation results. For example, a proposed humanoid operation may satisfy physical safety validation while remaining constitutionally impermissible due to authority-domain restrictions, persona constraints, mission limitations, constitutional hierarchy, ownership restrictions, jurisdictional requirements, organizational governance, or other constitutional provisions.

The constitutional enforcement outputs may be provided to one or more downstream systems including PAIOS services, ROS2 pathways, validation modules, actuation-dispatch trust services, actuator firewall interface modules, actuator drivers, actuator controllers, or other physical execution components. In this manner, the constitutional engine 240 governs whether, and under what constitutional constraints, proposed humanoid operations may proceed toward physical execution.

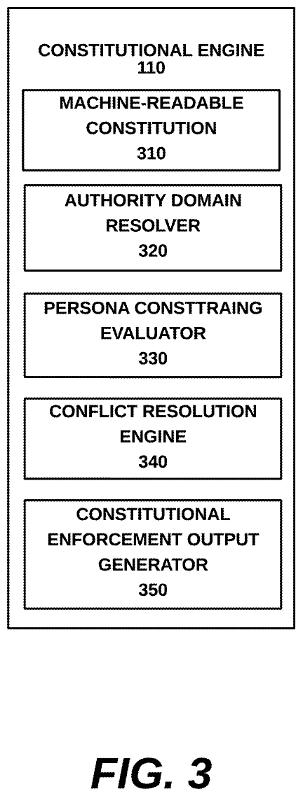

### C. Detailed Constitutional Engine (FIG. 3)

FIG. 3 illustrates a constitutional engine 300, according to an embodiment. The constitutional engine 300 may include a machine-readable constitution store 310, a constitution loader 320, an authority-domain resolver 330, a persona constraint evaluator 340, a constitutional hierarchy or conflict resolution engine 350, and a constitutional enforcement output generator 360.

The machine-readable constitution store 310 may store a machine-readable constitution defining constitutional provisions, authority domains, persona constraints, or constitutional priority relationships. The constitution loader 320 may load, parse, instantiate, or otherwise make available one or more constitutional runtime objects. The authority domain resolver 330 may determine which authority domains apply to a proposed humanoid operation. The persona constraint evaluator 340 may determine one or more role states, persona states, or role-bound behavioral constraints applicable to the proposed humanoid operation. The conflict resolution engine 350 may resolve conflicts among constitutional provisions according to a constitutional hierarchy. The constitutional enforcement-output generator 360 may generate one or more constitutional enforcement outputs.

The constitutional enforcement outputs may include a permit decision, deny decision, modify decision, constrained action descriptor, constitutional metadata object, constitutional release token, required-validator indicator, or downstream constraint object. Such outputs may be provided to one or more downstream systems including PAIOS services, ROS2 pathways, validation layers, actuation-dispatch trust layers, or actuator firewall layers.

### II. Methods

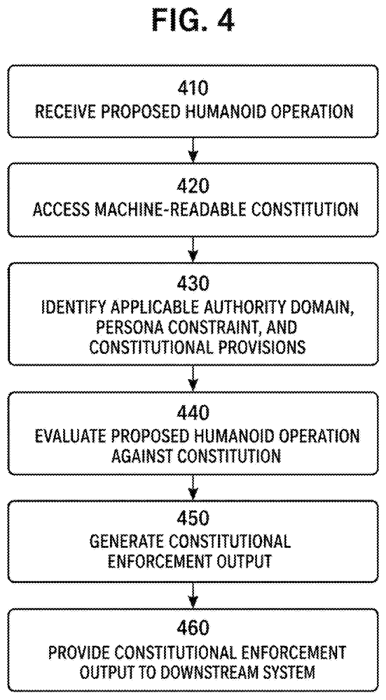

### A. Overall Constitutional Governance Method (FIG. 4)

FIG. 4 illustrates an overall method 400 for governing a proposed humanoid operation using a humanoid robot constitution, according to an embodiment. The method 400 may be performed by a constitutional runtime, constitutional engine, PAIOS service, trusted middleware service, onboard robot processor, edge server associated with the humanoid robot, or a distributed combination thereof.

At step 410, a proposed humanoid operation is received. The proposed humanoid operation may be received from an application, mission planner, behavior tree, large language model, vision-language-action model, learned robot policy, operator interface, fleet controller, ROS2 node, middleware service, or other upstream control source. The proposed humanoid operation may include a locomotion operation, manipulation operation, speech operation, gaze operation, sensing operation, disclosure operation, role-adoption operation, mission operation, navigation operation, or human-interaction operation.

At step 420, a machine-readable constitution is accessed. The machine-readable constitution may be stored locally on the humanoid robot, within a protected PAIOS runtime service, in a trusted memory region, in a secure enclave, or in a remote service associated with the humanoid robot. The machine-readable constitution may define constitutional provisions, authority domains, persona constraints, role states, constitutional priority relationships, downstream enforcement bindings, and other governance data.

At step 430, one or more authority domains, persona constraints, or constitutional provisions applicable to the proposed humanoid operation are identified. The authority domains may include, without limitation, owner, custodian, employer, household, premises, local law, public space, emergency responder, manufacturer, bystander, or data-subject domains. The persona constraints may include constraints on speech style, gesture, gaze, proxemic distance, manipulation force, sensing behavior, disclosure behavior, public-space mode, child safe mode, workplace mode, emergency mode, maintenance mode, or other role bound behavior.

At step 440, the proposed humanoid operation is evaluated against the applicable constitutional provisions. The evaluation may determine whether the proposed humanoid operation is constitutionally permitted, constitutionally prohibited, conditionally permitted, subject to modification, subject to routing through a lower validation layer, or subject to escalation. In some embodiments, the evaluation includes resolving a conflict between two or more applicable constitutional provisions according to a constitutional hierarchy, priority table, rule-priority graph, conflict-resolution rule, or other machine-readable priority relationship.

At step 450, a constitutional enforcement output is generated. The constitutional enforcement output may include a permit decision, deny decision, modify decision, route decision, constrained action descriptor, constitutional metadata object, constitutional release token, required-validator indicator, downstream constraint object, or other machine-readable output. The constitutional enforcement output may constrain at least one parameter of the proposed humanoid operation, including trajectory, velocity, force, torque, proxemic distance, gaze orientation, sensing permission, disclosure permission, speech content, manipulation envelope, or navigation region.

At step 460, the constitutional enforcement output is provided to one or more downstream systems. The downstream systems may include a PAIOS service, ROS2 middleware pathway, robot middleware layer, validation layer, actuation-dispatch trust layer, actuator firewall, actuator driver, actuator controller, mission authorization layer, navigation subsystem, manipulation subsystem, communication subsystem, or audit subsystem. In some embodiments, downstream execution of the proposed humanoid operation is prevented, modified, delayed, routed, or conditioned unless the constitutional enforcement output satisfies one or more downstream acceptance conditions.

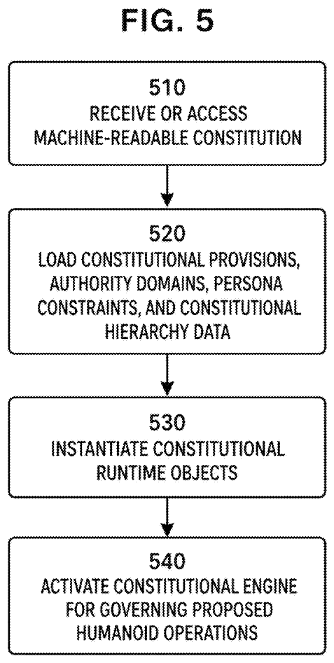

### B. Constitution Loading/Runtime Instantiation Method (FIG. 5)

FIG. 5 illustrates a method 500 for loading or instantiating a machine-readable constitution and constitutional runtime objects, according to an embodiment. The method 500 may be performed during robot startup, PAIOS boot, constitution installation, mission initialization, persona-state transition, role-adoption request, location transition, policy update, or another initialization or reconfiguration event.

At step 510, a machine-readable constitution is received or accessed. The machine-readable constitution may be received from local memory, a secure storage element, a manufacturer image, an owner device, a fleet-management service, a PAIOS registry, a cloud constitution service, or another trusted source. In some embodiments, the machine-readable constitution is verified using a signature, hash, version identifier, robot identifier, compatibility identifier, issuer credential, validity period, or other integrity data before being used.

At step 520, one or more constitutional provisions, authority domains, persona constraints, or constitutional hierarchy data are loaded. The loaded data may include authority-domain definitions, persona-state definitions, role constraints, provision identifiers, priority relationships, enforcement bindings, downstream subsystem identifiers, ROS2 pathway identifiers, validation-layer requirements, actuation-dispatch requirements, and actuator-firewall interface data. In some embodiments, the data is parsed, normalized, indexed, or otherwise transformed into one or more structures suitable for bounded-latency runtime evaluation.

At step 530, one or more constitutional runtime objects are instantiated. The constitutional runtime objects may include authority-domain objects, persona constraint objects, role-state objects, conflict-resolution objects, constitutional hierarchy objects, enforcement-output objects, downstream interface objects, or other runtime governance objects. In some embodiments, the constitutional runtime objects include lookup tables, priority tables, rule graphs, state machines, bitmasks, policy records, or other data structures configured to reduce runtime decision latency during humanoid robot operation.

At step 540, the constitutional engine is activated for use in governing proposed humanoid operations. Activation may include registering the constitutional engine with a PAIOS service, binding the constitutional engine to one or more ROS2 topics, ROS2 services, ROS2 actions, middleware pathways, validation services, actuation-dispatch services, actuator firewall interfaces, or controller pathways. After activation, proposed humanoid operations may be evaluated by the constitutional engine before being propagated into lower execution layers.

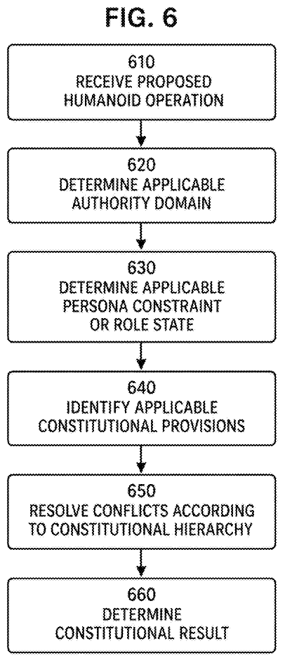

### C. Proposed Operation Evaluation Method (FIG. 6)

FIG. 6 illustrates a method 600 for evaluating a proposed humanoid operation against authority domains, persona constraints, and a constitutional hierarchy, according to an embodiment. The method 600 may be performed for each proposed humanoid operation, for selected high-risk operations, for operations associated with a role transition, or for operations that satisfy a constitutional evaluation trigger.

At step 610, a proposed humanoid operation is received. The proposed humanoid operation may be represented as a task instruction, action object, behavior-tree invocation, ROS2 message, ROS2 action request, middleware command, mission request, speech request, sensing request, manipulation request, locomotion request, or other machine-interpretable operation. In some embodiments, the proposed humanoid operation includes metadata identifying a source model, source process, mission identifier, role request, object identity, human-proximity condition, location, authority source, confidence score, or requested downstream subsystem.

At step 620, an applicable authority domain is determined. The constitutional engine may determine the applicable authority domain based on the source of the proposed operation, authenticated user identity, custodian state, owner state, employer state, premises location, local-law data, public-space classification, emergency condition, bystander status, data-subject relationship, or other contextual information. In some embodiments, more than one authority domain applies, and the constitutional engine identifies a plurality of potentially conflicting authority domains for later conflict resolution.

At step 630, an applicable persona constraint or role state is determined. The constitutional engine may determine whether the humanoid robot is operating in a household mode, workplace mode, public-space mode, child-safe mode, elder-care mode, emergency mode, maintenance mode, entertainment mode, service mode, or another persona or role state. The applicable persona constraint may limit speech, gaze, gesture, proxemic distance, manipulation force, sensing behavior, disclosure behavior, navigation behavior, or other outward-facing humanoid behavior.

At step 640, one or more applicable constitutional provisions are identified. The applicable constitutional provisions may be identified based on operation type, authority domain, persona state, role state, location, human proximity, object class, mission state, sensing context, or downstream subsystem. For example, a proposed operation involving recording in a private room may invoke sensor-disclosure provisions, premises-domain provisions, data-subject provisions, and active persona-state provisions.

At step 650, a conflict among applicable provisions, if any, is resolved according to a constitutional hierarchy. The conflict may involve, for example, an owner command conflicting with a premises rule, an employer directive conflicting with a public-space obligation, a household command conflicting with a child-safe persona constraint, or a mission request conflicting with a local-law provision. The constitutional hierarchy may resolve the conflict using an ordered priority table, rule-priority graph, authority-domain precedence rule, exception rule, contextual override rule, or other machine-readable conflict-resolution structure.

At step 660, a constitutional result is determined. The constitutional result may indicate that the proposed humanoid operation is permitted, denied, modified, delayed, routed to another subsystem, subject to validation, subject to human approval, subject to a reduced envelope, or subject to logging or audit. The constitutional result may also identify one or more downstream conditions that must be satisfied before physical execution, such as validation-layer approval, state-bound dispatch authorization, actuator-firewall verification, or mission authorization.

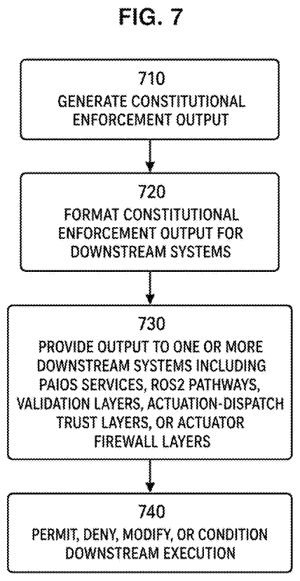

### D. Downstream Enforcement Output Method (FIG. 7)

FIG. 7 illustrates a method 700 for generating a constitutional enforcement output and providing the constitutional enforcement output to one or more downstream systems, according to an embodiment. The method 700 may be performed after a constitutional result is determined for a proposed humanoid operation.

At step 710, a constitutional enforcement output is generated based on the constitutional result. The constitutional enforcement output may encode a permit decision, deny decision, modify instruction, routing instruction, constrained action descriptor, required-validator indicator, constitutional release token, metadata object, audit entry, or downstream constraint. In some embodiments, the constitutional enforcement output includes an identifier of the active constitution version, active persona state, applicable authority domain, conflict-resolution result, and one or more constraints imposed on the proposed humanoid operation.

At step 720, the constitutional enforcement output is formatted for one or more downstream systems. Different downstream systems may require different representations of the same constitutional result, such as a ROS2-compatible message, PAIOS service call, validation-layer constraint object, actuation-dispatch authorization input, actuator-firewall metadata object, or driver-level constraint record. Formatting may include translating the constitutional enforcement output into a downstream schema, binding the output to a mission identifier, appending a signature or hash, adding a time window, or encoding constraints into a machine-readable envelope.

At step 730, the constitutional enforcement output is provided to a PAIOS service, ROS2 pathway, validation layer, actuation-dispatch trust layer, or actuator firewall layer. The constitutional enforcement output may control whether a proposed humanoid operation is published to a ROS2 topic, transmitted as a ROS2 action, provided to a ROS2 service, routed through a middleware pathway, submitted to a validation layer, passed to an actuation-dispatch trust layer, or delivered to an actuator firewall. In some embodiments, the output is provided to more than one downstream system so that constitutional constraints are carried through multiple layers of the physical execution stack.

At step 740, downstream execution is permitted, denied, modified, or conditioned based on the constitutional enforcement output. For example, a validation layer may receive a required-validator indicator, an actuation-dispatch trust layer may receive a constitutional condition for state-bound authorization, and an actuator firewall may receive a constitutional metadata object or release token. In some embodiments, a downstream layer refuses to process, dispatch, release, or execute a proposed humanoid operation unless the constitutional enforcement output is valid, current, and consistent with the operation being executed.

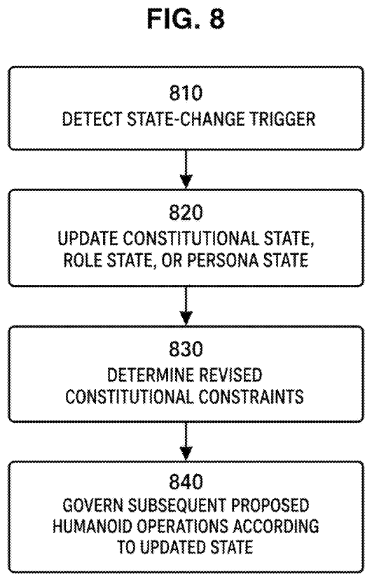

### E. Persona/Role/Constitutional State Update Method (FIG. 8)

FIG. 8 illustrates a method 800 for updating a constitutional state, role state, or persona state associated with a humanoid robot, according to an embodiment. The method 800 may be performed when the humanoid robot enters a new location, begins a new mission, receives a role adoption request, detects a new human interaction context, receives a change in authority domain, or transitions between private, public, workplace, household, emergency, or maintenance contexts.

At step 810, a state change trigger is detected. The state change trigger may include a role adoption request, mission start, mission termination, location change, premises entry, public space entry, emergency event, owner command, custodian command, employer command, local law update, sensor-context change, human-proximity change, or other contextual change. In some embodiments, the trigger is generated by a PAIOS service, ROS2 node, mission planner, localization system, operator interface, remote service, or constitutional runtime monitor.

At step 820, a role state, persona state, or constitutional state is updated. The update may cause the humanoid robot to enter a household assistant role, workplace assistant role, public guide role, child safe role, elder care role, emergency assistance role, maintenance role, restricted role, or another persona or operating state. The update may be stored as a runtime state variable, persona object, role token, constitutional state object, PAIOS state, middleware-visible state, or other machine-readable state.

At step 830, one or more revised constitutional constraints are determined. The revised constraints may alter permitted speech content, gaze behavior, proxemic distance, manipulation force, navigation region, sensing permissions, recording permissions, disclosure rules, downstream validator requirements, actuation dispatch requirements, or actuator-firewall conditions. In some embodiments, the revised constraints are determined by re-evaluating the active constitution against the updated persona state, authority domain, location, mission state, or human interaction context.

At step 840, subsequent proposed humanoid operations are governed according to the updated state. The constitutional engine may apply the updated role state, persona state, or constitutional state to future proposed humanoid operations before the operations are propagated to PAIOS services, ROS2 pathways, validation layers, actuation dispatch trust layers, actuator firewall layers, or actuator controllers. In some embodiments, already-pending proposed operations are re-evaluated, delayed, modified, or canceled when the updated state changes the constitutional permissibility of those operations.

### III. Generalities

The machine-readable constitution should not be interpreted as limited to a particular document format, language, syntax, or representation. Constitutions may be represented using structured data, object graphs, executable bytecode, interpreted scripts, declarative languages, ontologies, knowledge graphs, policy languages, domain-specific languages, databases, neural representations, symbolic representations, hybrid symbolic-neural representations, or other machine-readable forms.

In some embodiments, a constitution compiler converts one or more source constitutional specifications into executable constitutional runtime objects. The compiler may perform parsing, validation, optimization, dependency resolution, inheritance resolution, conflict detection, object generation, cryptographic signing, serialization, version management, or other compilation operations prior to deployment.

Constitutions may further support version management, staged deployment, rollback, cryptographic verification, digital signatures, secure updates, distributed synchronization, inheritance, modular extensions, constitutional plug-ins, or other lifecycle management operations.

The disclosed embodiments may be implemented in hardware, software, firmware, middleware, cloud services, edge services, onboard robot processors, secure enclaves, trusted execution environments, PAIOS runtime services, ROS2-compatible nodes, robot middleware services, actuator firewall services, validation services, or combinations thereof. Although certain examples describe humanoid robots, the disclosed constitutional runtime techniques may also be applied to other Physical AI systems, including mobile robots, quadruped robots, wheeled robots, robotic arms, autonomous vehicles, drones, wearable robots, service robots, industrial robots, robotic appliances, or other embodied artificial intelligence systems.

References to PAIOS, ROS2, validation layers, actuation-dispatch trust layers, actuator firewalls, drivers, actuator controllers, and motor-control systems are illustrative of downstream execution layers. In other embodiments, equivalent layers may be implemented using proprietary middleware, non-ROS robot operating systems, custom message buses, real-time control frameworks, safety controllers, hypervisor-based robot runtimes, microkernel services, driver frameworks, actuator command brokers, or vendor-specific robot control stacks.

The constitutional runtime may be implemented onboard a humanoid robot, remotely from the humanoid robot, or in a distributed manner. For example, low-latency constitutional evaluation may be performed onboard the robot while constitution distribution, update, logging, compliance reporting, or heavy policy compilation is performed by an edge server or cloud service. References to a constitutional engine associated with a humanoid robot include both onboard and offboard implementations that govern operation of the humanoid robot.

A proposed humanoid operation may be represented at different levels of abstraction. For example, a proposed humanoid operation may comprise a high-level mission, role transition, speech act, sensing request, disclosure request, behavior-tree selection, navigation request, manipulation request, ROS2 action request, middleware message, candidate action, joint-space trajectory, Cartesian trajectory, force profile, grip request, gaze orientation request, locomotion primitive, or other machine-interpretable operation.

The constitutional enforcement output may also be represented at different levels of abstraction. In some embodiments, the constitutional enforcement output is a high-level permit, deny, modify, or route decision. In other embodiments, the constitutional enforcement output includes a constrained action descriptor, release token, policy object, downstream schema object, validator requirement, persona-state object, authority-domain object, time-limited authorization, signed metadata, audit event, or machine-readable constraint envelope.

The terms “constitution,” “machine-readable constitution,” “constitutional runtime,” “constitutional engine,” “constitutional governance layer,” “governance manifest,” “policy stack,” “authority hierarchy,” and similar terms may refer to machine-interpretable data and runtime logic configured to govern operation of a humanoid robot or other Physical AI system. Such terms are not limited to a natural-language legal document or human-readable ethical statement, and may include structured data, executable logic, graphs, tables, state machines, tokens, manifests, rule sets, schemas, compiled runtime objects, or other machine-readable structures.

The particular ordering of steps shown in the methods is illustrative and not limiting. In various embodiments, steps may be performed in a different order, repeated, omitted, combined, divided, performed in parallel, or performed conditionally. For example, authority-domain determination, persona-constraint determination, constitutional provision identification, and conflict resolution may be performed sequentially, in parallel, or as part of a single lookup or graph traversal operation.

Although examples refer to ROS2 topics, ROS2 services, and ROS2 actions, the disclosed techniques are not limited to ROS2. The constitutional runtime may govern any middleware message, service call, action call, command queue, shared memory command, driver call, system call, API invocation, behavior-tree tick, controller command, or other execution pathway by which a humanoid robot or Physical AI system proceeds toward sensing, communication, movement, manipulation, or physical actuation.

Likewise, although examples refer to downstream validation layers, actuation dispatch trust layers, and actuator firewalls, the constitutional runtime need not itself perform physical safety prediction, actuator dispatch ownership, motor-driver control, or actuator side release enforcement. Instead, the constitutional runtime may determine constitutional permissibility and provide constitutional outputs that constrain or condition such lower layer functions. In this manner, constitutional governance is architecturally separable from physical validation, mandatory actuation dispatch, and actuator firewall enforcement while remaining interoperable with each layer.

The disclosed subject matter may be embodied as a system, method, apparatus, robot, humanoid robot, Physical AI platform, operating system service, middleware service, computer-readable medium, runtime environment, cloud service, edge service, software development kit, interface layer, or combination thereof. Features described with respect to one embodiment may be combined with features described with respect to another embodiment unless the context clearly indicates otherwise. The scope of the disclosure is not limited by the examples, figure labels, component names, or specific implementation environments described herein.

I claim:

1. A humanoid robot comprising:
a humanoid body including a plurality of actuators configured to move one or more appendages of the humanoid body;
one or more sensors;
one or more processors; and
memory storing a machine-readable constitution defining constitutional provisions for the humanoid robot, the machine-readable constitution comprising a plurality of authority domains and one or more persona constraints;
wherein the one or more processors are configured to execute a constitutional runtime associated with a Physical Artificial Intelligence Operating System (PAIOS), the constitutional runtime configured to:
receive a proposed humanoid operation before the proposed humanoid operation is propagated to a lower execution layer;
determine at least one authority domain applicable to the proposed humanoid operation;
determine at least one persona constraint applicable to the proposed humanoid operation;
evaluate the proposed humanoid operation against the machine-readable constitution based on the at least one authority domain and the at least one persona constraint; and
generate a constitutional enforcement output that constrains propagation of the proposed humanoid operation to the lower execution layer.

2. The humanoid robot of claim 1, wherein the lower execution layer comprises at least one of a ROS2 middleware layer, a robot middleware layer, a validation layer, an actuation-dispatch trust layer, an actuator firewall, an actuator driver, or an actuator controller.

3. The humanoid robot of claim 1, wherein the constitutional runtime is implemented as a privileged runtime service of the PAIOS.

4. The humanoid robot of claim 1, wherein the constitutional runtime is configured to control whether the proposed humanoid operation is published to a ROS2 topic, transmitted as a ROS2 action, provided to a ROS2 service, or routed to a robot controller through a middleware pathway.

5. The humanoid robot of claim 1, wherein the constitutional enforcement output comprises at least one of a permit decision, deny decision, modify decision, route decision, constrained action descriptor, constitutional metadata object, constitutional release token, required-validator indicator, or downstream constraint object.

6. The humanoid robot of claim 1, wherein the proposed humanoid operation comprises at least one of a locomotion operation, manipulation operation, speech operation, gaze operation, sensing operation, recording operation, disclosure operation, role-adoption operation, mission operation, or human-interaction operation.

7. The humanoid robot of claim 1, wherein the proposed humanoid operation is generated by at least one of an application, mission planner, behavior tree, large language model, vision-language-action model, learned robot policy, remote operator interface, or fleet controller.

8. The humanoid robot of claim 1, wherein the plurality of authority domains include at least two of an owner domain, custodian domain, employer domain, household domain, premises domain, local-law domain, public-space domain, emergency-responder domain, manufacturer domain, bystander domain, or data-subject domain.

9. The humanoid robot of claim 1, wherein the one or more persona constraints govern at least one of speech style, gesture, gaze, proxemic distance, manipulation force, locomotion style, sensing behavior, disclosure behavior, public-space mode, household mode, workplace mode, child-safe mode, emergency mode, or maintenance mode.

10. The humanoid robot of claim 1, wherein the constitutional runtime is configured to resolve a conflict between a first constitutional provision associated with a first authority domain and a second constitutional provision associated with a second authority domain before generating the constitutional enforcement output.

11. The humanoid robot of claim 1, wherein the constitutional enforcement output is provided to a validation layer configured to evaluate physical feasibility or physical safety of the proposed humanoid operation.

12. The humanoid robot of claim 1, wherein the constitutional enforcement output is provided to an actuation-dispatch trust layer configured to require state-bound authorization before actuator dispatch.

13. The humanoid robot of claim 1, wherein the constitutional enforcement output is provided to an actuator firewall configured to perform actuator-side gating or command-release control.

14. A computer-implemented method for governing operation of a humanoid robot, comprising:
receiving, by a constitutional runtime associated with a humanoid robot, a proposed humanoid operation before the proposed humanoid operation is propagated to a lower execution layer;
accessing a machine-readable constitution associated with the humanoid robot;
identifying one or more constitutional provisions applicable to the proposed humanoid operation;
determining an authority domain associated with the proposed humanoid operation;
determining a persona constraint associated with the proposed humanoid operation;
evaluating the proposed humanoid operation based on the one or more constitutional provisions, the authority domain, and the persona constraint;
generating a constitutional enforcement output; and
providing the constitutional enforcement output to one or more downstream systems to permit, deny, modify, route, or condition the proposed humanoid operation.

15. The method of claim 14, wherein the one or more downstream systems comprise at least one of a PAIOS service, ROS2 middleware pathway, validation layer, actuation-dispatch trust layer, actuator firewall, actuator driver, or actuator controller.

16. The method of claim 14, wherein evaluating the proposed humanoid operation comprises resolving a conflict between a first authority domain and a second authority domain according to a constitutional hierarchy of the machine-readable constitution.

17. The method of claim 14, wherein the constitutional enforcement output comprises a constrained action descriptor that bounds at least one parameter of the proposed humanoid operation.

18. The method of claim 17, wherein the at least one parameter comprises at least one of trajectory, velocity, force, torque, proxemic distance, gaze orientation, sensing permission, disclosure permission, speech constraint, manipulation envelope, or navigation region.

19. A non-transitory computer-readable medium storing instructions that, when executed by one or more processors, cause the one or more processors to:
instantiate a constitutional runtime associated with a humanoid robot;
access a machine-readable constitution defining constitutional provisions, authority domains, and persona constraints for the humanoid robot;
receive a proposed humanoid operation from an upstream control source;
evaluate the proposed humanoid operation against the machine-readable constitution before the proposed humanoid operation is propagated into a lower execution layer comprising at least one of a PAIOS service, ROS2 middleware layer, validation layer, actuation-dispatch trust layer, or actuator firewall; and
generate a constitutional enforcement output that constrains downstream execution of the proposed humanoid operation.

20. The non-transitory computer-readable medium of claim 19, wherein the upstream control source comprises at least one of an application, mission planner, behavior tree, large language model, vision-language-action model, learned robot policy, remote operator interface, or fleet controller.
